(19) United States
(12) Patent Application Publication
(10) Pub. No.: US 2019/0394694 A1
(43) Pub. Date: Dec. 26, 2019

(54) METHOD AND DEVICE FOR FACILITATING CELLULAR HANDOVER

(71) Applicant: THALES HOLDINGS UK PLC, Berkshire (GB)

(72) Inventors: Gary DENT, Berkshire (GB); Peter GILLICK, Berkshire (GB)

(21) Appl. No.: 16/448,719

(22) Filed: Jun. 21, 2019

(30) Foreign Application Priority Data
Jun. 21, 2018 (GB) 1810229.3

(51) Int. Cl. H04W 36/08; H04W 36/30; H04W 36/00; H04B 17/318; H04B 7/185; H04W 88/08

(52) U.S. Cl. CPC H04W 36/08; H04W 36/30; H04W 36/0058; H04W 88/085; H04B 17/318; H04B 7/18506; H04W 36/0094

(57) ABSTRACT

Provided herein are methods and devices for facilitating cellular handover in high Doppler environments. The method comprises receiving an input from one or more antennas, the input comprising a first component received over a first communication path from a serving base station and a second component received over a second communication path that is different to the first communication path. The method further comprises performing signal compensation on the first component over a communication branch, measuring one or more indications of strength, quality or frequency of the first component and communicating wirelessly with the serving base station over the communication branch; and in parallel to the communication branch, performing signal compensation on the second component over a measurement branch and measuring one or more indications of strength, quality or frequency of the second component in order to assist a decision regarding handover of communication to the second communication path.

### TECHNICAL FIELD

The present disclosure relates to a method and a system for communicating in a wireless network.

### BACKGROUND

The demand for higher data rates to aircraft is expected to increase in much the same way as observed for terrestrial mobile systems. Currently the majority of in-flight solutions utilise satellite links, however, an alternative solution is to utilise a direct air-to-ground (A2G) link with sufficient bandwidth. One such solution being investigated utilises adapted 4G cellular Long Term Evolution (LTE) technology. This technology should offer higher bandwidth at lower cost.

Adopting this technology for use in an airborne environment is not without its challenges. A significant challenge in an airborne system is the larger Doppler shift experienced by the user due to the high aircraft speeds. This larger Doppler shift creates a number of problems that are not present to the same extent in a terrestrial system. One such problem is that neighbour cells have significantly different Doppler frequency offsets, this is unlike the terrestrial system where the frequency difference due to Doppler is small enough to assume that a neighbouring cell can be observed at its nominal frequency. This is important for a number of reasons, not least when measuring a neighbouring cell's signal quality. In a terrestrial environment with little or no Doppler shift, a mobile device can measure a neighbouring cell's transmission without the need to acquire the Doppler offset which saves substantial time and complexity. In contrast, in an airborne environment where communication experiences large Doppler shifts the device requires more time to accurately acquire the correct frequency. This increased acquisition time can adversely affect throughput of the network in addition to the accuracy of neighbouring cell measurements.

In many communication systems, including LTE, cell selection and handover is based on the signal power and signal quality measured for neighbouring cells. As a consequence inaccurate measurement can prevent cell selection and handover operating as it was intended; leading to intermittent service, signal outages and loss of data.

The LTE specification as defined by the 3^{rd} Generation Project Partnership (3GPP) contains specific provision for measuring cell power and quality. By correlating a signal received from a neighbouring base station with an expected reference signal it is possible to measure the signal quality or signal power of a neighbouring cell.

In situations where neighbouring cells are on the same frequency, measurements can be made whilst still transmitting to the serving cell. In contrast, when neighbouring cells are on different frequencies, communication must stop and the User Equipment (UE) must retune to the frequency of the neighbouring cell. The LTE standard includes a short interval of 6 ms every 40 or 80 ms for this very purpose. This interval is referred to as “the measurement gap”.

During the measurement gap a UE must retune to the nominal frequency of the neighbouring cell, acquire the actual cell transmission and subsequently perform the appropriate measurements. Measuring neighbouring cells in this way can be a processor intensive activity. Furthermore, in environments where there is a large Doppler shift, it is foreseeable that the duration of the measurement gap may not be long enough to accurately acquire a neighbouring cell's transmission, thereby affecting the accuracy of the measurements.

In light of the above, there is a need for an improved means of managing communications, particularly for use in high Doppler environments.

### SUMMARY

According to a first aspect there is provided a method comprising receiving an input from one or more antennas, the input comprising: a first component received over a first communication path from a serving base station and a second component received over a second communication path that is different to the first communication path. The method further comprises performing signal compensation on the first component over a communication branch, measuring one or more indications of strength, quality or frequency of the first component and communicating wirelessly with the serving base station over the communication branch. The method further comprises, in parallel to the communication branch, performing signal compensation on the second component over a measurement branch and measuring one or more indications of strength, quality or frequency of the second component in order to assist a decision regarding handover of communication to the second communication path.

This is particularly advantageous as the use of an independent measurement branch for processing a signal allows for a signal to be compensated and measured without affecting the communication branch. Furthermore, independent signal compensation ensures that the measurements on each branch are more accurate, facilitating more effective handover. For example, in situations where measurements of a neighbouring cell are required, by using a second independent path, the method can measure and correct for the frequency offset of the neighbouring cell without having to interrupt the correction and tracking being applied to the communication branch. Measurements recorded by the measurement branch can be used to enable quick and accurate acquisition of a neighbouring cell transmission when the communication branch is required to measure a neighbouring cell (e.g. when using a measurement gap). Additionally the measurement branch can also be used to report measurements of neighbouring cells to the communication branch, thereby removing the need to stop serving cell communications to perform measurements. This is particularly advantageous in situations where the one or more antennas are moving at high velocity as the Doppler effect can cause the two component signals to have a large frequency shift relative to each other.

Communication may be over a wireless communication channel, such as an LTE channel. Handover may be handover from a serving base station to a further base station. Handover may comprise transferring the communication channel from the serving base station to a further base station followed by communicating wirelessly with further base station. The further base station may be a neighbouring base station. Alternatively, as shall be discussed later, handover may be handover to a different receiving antenna or antenna element.

The frequency of the second component measured by the measurement branch may be communicated to the communication branch. The first and second components may derive from a device comprising a dual tuner connected to the one or more antennas. The first and second components may be transmissions on the same, or a different, nominal frequency.

In a further embodiment signal compensation comprises one or more of frequency compensation or channel equalisation.

Independently compensating a signal in this way is particularly advantageous as it allows more time for accurate signal acquisition thereby ensuring more accurate measurement of the strength, quality of frequency of the respective components for assessing handover. Furthermore, by using an independent means of signal compensation the acquisition of the signal is not limited to the break in communications with the serving cell. As a result the throughput of the system can be improved.

In a further embodiment the method comprises assisting in a decision regarding handover of communication to the second communication path. Assisting in a decision comprises: comparing the indications of one or more of strength, quality or frequency of the first component and the one or more indications of strength, quality or frequency of the second component; and making a decision based on the comparison to switch the first component of the input from the signal received over the first communication path to the signal received over the second communication path.

By using an independent measurement branch the measurements obtained for the strength, quality or frequency of the second component can be more accurate, especially in high Doppler environments where there may be a large frequency offset. As a result, a more accurate decision can be made regarding whether to handover communication.

In a further embodiment each of the measured one or more indications of strength or quality are communicated to the serving base station to allow the serving base station to determine whether to initiate handover of communication to the second communication path. This allows the serving base station to determine whether handover should be made, and to communicate this decision to the system.

Alternatively the method may determine whether to initiate handover.

In a further embodiment the first communication path is a path between the serving base station and the one or more antennas; and the second communication path is a path between a further base station and the one or more antennas. This means that the two components are received from different base stations. This allows the method to facilitate handover between the base stations.

Use of a second independent compensation path is particularly advantageous where, due to Doppler, the further base station is observed on a frequency which is different to its nominal frequency.

In a further embodiment the one or more antennas comprise a first antenna and a second antenna and the first communication path is a path between the serving base station and the first antenna; and the second communication path is either a path between the serving base station and the second antenna or a path between a further base station and the second antenna. That is, the two components may be received via different antennas, so handover may be facilitated to switch between the antennas. This allows the method to make use of spatial diversity.

This is advantageous as it enables the measurement branch to be used for acquiring accurate measurements of the neighbouring cells as well as for spatial diversity. By measuring the signal from the serving base station the method is able to select which antenna of the first and second antennas is more suitable for communication with the serving cell. In addition, where the second component is from a further base station via the second antenna, the method is able to facilitate handover both between the antennas and between the base stations.

Each antenna of the one or more antennas may be associated with a different remote radio head. The first antenna and the second antenna may be spatially diverse. The first antenna and second antenna may also be connected to a single remote radio head comprising a dual tuner.

In a further embodiment each antenna of the one or more antennas comprises a first antenna element and a second antenna element. In this embodiment the first communication path is a path between the serving base station and the first antenna element; and the second communication path is either a path between the serving base station and the second antenna element or a path between a further base station and the second antenna element.

This is advantageous as it enables the determination of the most effective antenna element (or set of antenna elements) for communication. This may be achieved without interrupting serving cell communication. This is particularly applicable to MIMO communications.

Each antenna of the one or more antennas may comprise multiple antenna elements. The selected antenna elements may be switchable within the same antenna, or in the case of the antenna being switched, the selected antenna elements may be switched to a new configuration for use on the newly selected antenna.

In a further embodiment the one or more indications of strength or quality comprise one or more of an indication of received signal power and an indication of received signal quality.

In an LTE system the indication of strength may be the Reference Signal Received Power (RSRP) and the indication of quality may be the Reference Signal Received Quality (RSRQ).

In a further embodiment measuring one or more indications of strength, quality or frequency of the second component comprises measuring a frequency offset of the second component of the input signal.

This is advantageous as frequency offsets can assist in the accurate and timely acquisition of the signal from the further base station for measuring one or more indications of strength or quality of the signal from the further base station.

Frequency offset may be the difference in frequency between the signal from the further base station and the signal from the serving base station. Frequency offset may be the difference between the observed frequency of the signal from the further base station and the nominal frequency of the further base station. The measurement of frequency offset may be communicated to the communication branch.

In a further embodiment the communication branch comprises a first modem and the measurement branch comprises a second modem, wherein communicating wirelessly with the serving base station is performed by the first modem and the measurement of the one or more indications of strength or quality of the second component is performed by the second modem.

Wireless communication may take place in a Long Term Evolution (LTE) network. The signal from the further base station may be a reference signal which may include an identifier of the further base station (e.g. cell-specific reference signal). The second modem may be replaced by a frequency acquisition function.

According to a second aspect there is provided a device for communicating in a wireless network, the device comprising: an input for receiving a signal from the wireless network, the signal comprising a first component received over a first communication path from a serving base station and a second component received over a second communication path that is different from the first communication path; an output for outputting a signal to the wireless network; a communication branch connected to the input and output and configured to perform signal compensation on the first component, measure one or more indications of strength, quality or frequency of the first component and communicate wirelessly with the serving base station via the input and the output; and a measurement branch connected to the input and output in parallel to the communication branch and configured to perform signal compensation on the second component and measure one or more indications of strength, quality or frequency of the second component in order to assist a decision regarding handover of communication to the second communication path.

In a further embodiment signal compensation comprises one or more of frequency compensation or channel equalisation.

In a further embodiment assisting in a decision regarding handover of communication to the second communication path comprises: comparing the one or more indications of strength, quality or frequency of the first component and the one or more indications of strength, quality, or frequency of the second component; and making a decision based on the comparison to switch the first component of the input from the signal received over the first communication path to the signal received over the second communication path.

In an embodiment the device is further configured to communicate each of the measured one or more indications of strength or quality to the serving base station, via the output, to allow the serving base station to determine whether to initiate handover of communication to the second communication path.

In a further embodiment the first communication path is a path between the serving base station and the one or more antennas; and the second communication path is a path between a further base station and the one or more antennas.

In a further embodiment the one or more antennas comprise a first antenna and a second antenna. In this embodiment the first communication path is a path between the serving base station and the first antenna; and the second communication path is either a path between the serving base station and the second antenna or a path between a further base station and the second antenna.

In a further embodiment each antenna of the one or more antennas comprises a first antenna element and a second antenna element. In this embodiment the first communication path is a path between the serving base station and the first antenna element; and the second communication path is either a path between the serving base station and the second antenna element or a path between a further base station and the second antenna element.

In a further embodiment the one or more indications of strength or quality comprise one or more of an indication of received signal power and an indication of received signal quality.

In a further embodiment measuring one or more indications of strength, quality or frequency of the second component comprises measuring a frequency offset of the second component of the input signal.

In a further embodiment the communication branch comprises a first modem and the measurement branch comprises a second modem, wherein communicating wirelessly with the serving base station is performed by the first modem and the measurement of the one or more indications of strength or quality of the second component is performed by the second modem.

### BRIEF DESCRIPTION OF THE DRAWINGS

Arrangements of the present invention will be understood and appreciated more fully from the following detailed description, made by way of example only and taken in conjunction with drawings in which:

FIG. 1 shows a scenario in which embodiments may be employed;

FIG. 2 shows a visual representation of the measurement gap in an LTE system;

FIG. 3 shows a method for controlling handover according to one embodiment in which neighbouring cells are measured;

FIG. 4 shows a method for controlling handover according to one embodiment in which a neighbouring cell frequency offset is measured;

FIG. 5 shows a method for selecting the antenna unit used for communicating with a serving cell according to one embodiment;

FIG. 6 shows a device for use in wireless communication according to one embodiment;

FIG. 7 shows a device for use in wireless communication according to one embodiment wherein measurement of the wireless network is performed by frequency acquisition functions;

FIG. 8 shows an exemplary LTE UE receiver architecture;

FIG. 9 shows a receiver architecture comprising additional components used to implement a frequency acquisition function according to an embodiment;

FIG. 10 shows a device for use in wireless communication according to one embodiment wherein each modem is served by a different remote radio head;

FIG. 11 shows a device for use in wireless communication according to one embodiment wherein the frequency acquisition functions are fed by a different remote radio head to the modem;

FIG. 12 shows a device for use in wireless communication according to one embodiment wherein a switch is used to control which remote radio head is used to feed each modem; and

FIG. 13 shows a device for use in wireless communication according to one embodiment wherein a remote radio head (RRH) comprises a plurality of independent channel tuners.

### DETAILED DESCRIPTION

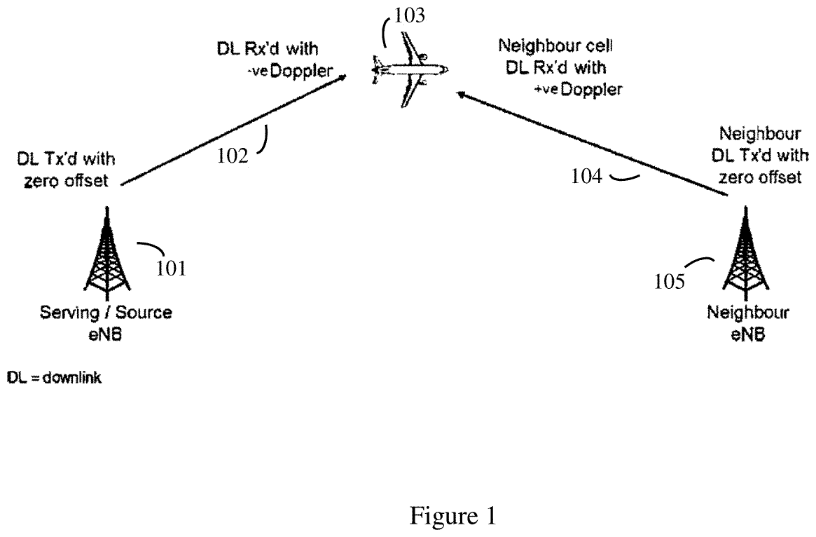

FIG. 1 shows an exemplary situation in which embodiments may be employed. FIG. 1 shows a User Equipment, UE, 103 device in communication with a serving cell 101. In addition to communicating with the serving cell 102, the UE also receives a signal 104 from a neighbouring base station 105 to which the UE is not currently in communication with.

In the remainder of the description, a “neighbouring cell” is considered to mean a base station capable of communicating with UE. The letters “UE”, in the context of the present description, may relate to a mobile device, or any other device capable of wirelessly connecting to a base station. In keeping with terminology used by persons skilled in the art, the acronym eNodeB denotes a base station. The uplink means a communication of the mobile equipment to the base station, and the downlink means a communication from the base station to the mobile equipment.

When a UE moves relative to the base station a Doppler frequency shift is introduced. This Doppler shift can significantly affect the observed operating frequency of neighbouring cells. The Doppler effect, referred to as “Doppler”, “Doppler spreading” or “Doppler shifting”, is a term used to describe the frequency offset of a wave (mechanical, acoustic, electromagnetic, etc.) between the measurement on transmission and the measurement on reception, when the distance between a transmitter and a receiver varies over time.

In wireless environments, it is often possible to have multiple paths between the eNodeB and the UE, as a consequence signals travelling along different paths (and therefore distances) will have different Doppler shifts. In the case of an air-to-ground (A2G) channel the aircraft is normally in direct view or LOS (Line-Of-Sight) of the base station and consequently there is a predominant Doppler shift to which all communication has been shifted.

In communication networks, serving cells often have knowledge of nearby cells and before the handover procedure begins the serving cell communicates neighbouring cell information to the UE. In some networks, measurements made by the UE are used to inform whether the UE should disconnect from the serving cell and connect to a neighbouring cell, in other words, the measurements performed by the UE can decide handover.

As described in the background section; situations can arise whereby neighbouring cells, when observed from the perspective of the UE device, do not appear to be operating at their designated operating frequency. This is particularly problematic when attempting to accurately measure the power or quality of neighbouring cells.

To solve this problem various methods and devices for communicating in a wireless network are presented herein. The embodiments described below are presented in the context of standards provided by the 3^{rd} Generation Partnership Project (3GPP), however for the avoidance of doubt; the methods and systems presented below are equally as applicable to any other wireless networks.

Example technologies provided by 3GPP include Long Term evolution (LTE) and LTE Advanced. This includes both Frequency Division Duplexing (FDD) and Time Division Duplexing (TDD) modes. As described throughout the application, the methods and devices presented herein can be used for intra-frequency measurements where neighbouring cells transmit on the same frequency as the serving cell in addition to inter-frequency measurements; where neighbouring cells use different carrier frequencies to the serving cell.

There are a number of different ways to measure signal strength and signal quality in a wireless network. In an LTE network one way to measure the power of serving cell and neighbouring cells is to use the Reference Signal Received Power (RSRP). Within an LTE network there are two separate channels, the uplink and the downlink. Contained within the LTE downlink is a Cell-Specific Reference Signal (CRS), this signal contains information specific to the cell it originated from and can be used to measure neighbouring cells (and the serving cell), on the same frequency or a different frequency to that of the serving cell.

Technical Specification (TS) 3GPP 36.211 provides a graphical representation of the Cell-Specific Reference Signal along with details of how to calculate it. The same technical specification details the parameters used to calculate the sequence, which include, amongst other parameters, the cell identification (Cell ID) of the base station. As a result each cell (among the 504 physical identities) uses a different sequence, making it possible to differentiate neighbouring cells in a unique way.

RSRP is defined in 3GPP 36.214 as the linear average of the power contributions, in Watts, taken over the resource blocks (RBs) that carry cell-specific reference signals.

In addition to the power of the reference signal, the quality of a downlink signal can also be measured using the quality of a received signal, for instance, the Reference Signal Received Quality (RSRQ). The RSRQ is defined in 3GPP TS 36.214 as (N×RSRP)/RSSI, where N is the number of resource blocks over which the measurement is performed, RSRP is the reference signal received power and RSSI (Reference Signal Strength Indicator) is a measurement of all the power present in the received radio signal. RSSI is a measure before demodulation, whereas RSRP and RSRQ require a demodulated signal in order to extract the reference signals from the data stream.

These measurements may be communicated to the serving cell base station. Communicating the measurements in this way enables the serving cell base station to make the decision regarding UE handover. In a further embodiment the handover decision could be made by the UE.

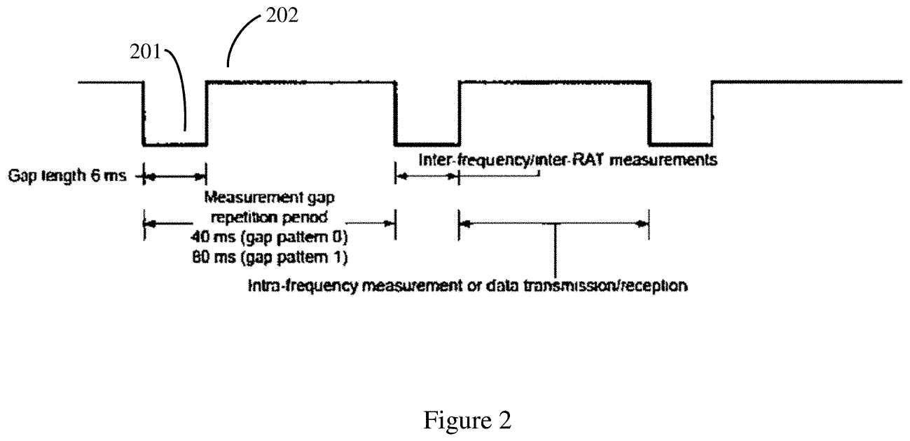

FIG. 2 shows a visual representation of the measurement gap in an LTE system. In the LTE standard a measurement gap is used whenever neighbouring base stations use a different frequency to the serving base station. The LTE standard specifies that the measurement gap consists of a short interval 201 of 6 ms every 40 or 80 ms 202 for measuring neighbouring cells. Having said this, any measurement gap of any length, and repeating according to any suitable frequency, may be used in accordance with alternative methods. During the measurement gap the UE stops transmitting in order to avoid conflict with the measurement of signals from neighbouring cells and to allow tuning to the neighbouring cell's frequency.

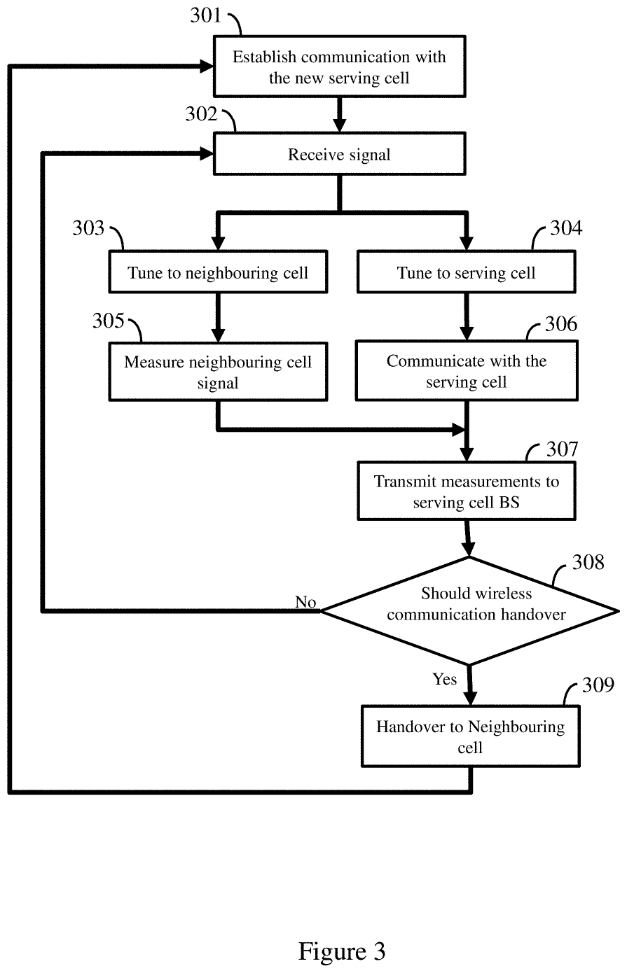

FIG. 3 shows a method for controlling handover according to one embodiment in which neighbouring cells are measured. The method begins by establishing wireless communication with the new serving cell 301. Wireless communication can take many forms and can include any communication according to any appropriate communication standard. In addition to receiving a signal from the serving cell, signals from neighbouring cells are also received 302.

The component of the received signal which relates to the serving cell signal may experience a different Doppler frequency shift than is associated with the component of the received signal associated with a neighbouring cell. After receiving the signal the method subsequently tunes to the neighbouring cell transmission 303 and, in parallel, tunes to the serving cell transmission 304. Tuning involves adjusting a reception frequency of receiving circuitry (e.g. a downconverter) to match the frequency of the relevant transmission. Accurate tuning can take place in two steps: tuning to the nominal frequency, than compensating for any relatively small frequency offsets by acquiring the actual frequency. Once the actual frequency is acquired, the frequency is typically monitored so that any small changes can be tracked and compensated for, this is typically called automatic frequency control.

Tuning is a form of signal compensation. Other signal compensation mechanisms may be implemented, in addition to, or alternatively to, frequency tuning. For instance, channel equalisation may be applied independently to the two signals. This further helps improve measurement accuracy.

One or more measurements are subsequently made based on the compensated signals received from the neighbouring base stations 305. In one embodiment, measurements of neighbouring cells are only made when instructed to by the serving base station. In an alternative embodiment, measurements of neighbouring cells are triggered by an event such as the serving cell reference signal power becoming worse than a threshold.

The one or more measurements can include indications of the signal quality and/or signal strength of the neighbouring cell. In the present embodiment, the signal quality and signal strength can both be measured. These measurements occur in parallel to the wireless communication with the serving cell 306, ensuring communication with the serving cell is not interrupted.

By measuring neighbouring cells in a separate parallel function the processor loading on the main communication function can be reduced. This also allows measurements to be performed continuously. Measuring neighbouring cells continuously and in parallel to communication is particularly advantageous in systems with large Doppler offsets. The use of a parallel processing function allows a different Doppler frequency error to be corrected, prior to measurements, compared to the Doppler frequency error correction for serving cell processing. This provides more accurate measurements, and therefore ensures more accurate handover between base stations.

In accordance with the embodiment described above, once a neighbouring cell has been measured, the measurements are transmitted to the serving cell base station 307 and are subsequently used to inform a decision regarding handover of the wireless connection 308; from the serving cell to a neighbouring cell. In a LTE system the decision will be made by the base station of the serving cell after the UE has transmitted the measurements to the base station 307. The measurements are used to determine whether wireless communication handover should occur, for example, handover of communication may be initiated upon measuring a reference signal power or quality of a neighbouring cell that exceeds those for the serving cell by a threshold. If the serving base station initiates handover, it transmits an instruction to the system to begin handover. The handover instruction includes an indication of the neighbouring cell to which communication is to be handed over. The system then disconnects from the serving cell and hands over to the neighbouring cell 309, making the neighbouring cell the new serving cell. The method subsequently establishes communication to the new serving cell 301.

If it is determined that handover should not occur, then the communication channel with the serving cell is maintained and the method loops back to step 302 and the method repeats to determine whether handover should occur based on the new signals.

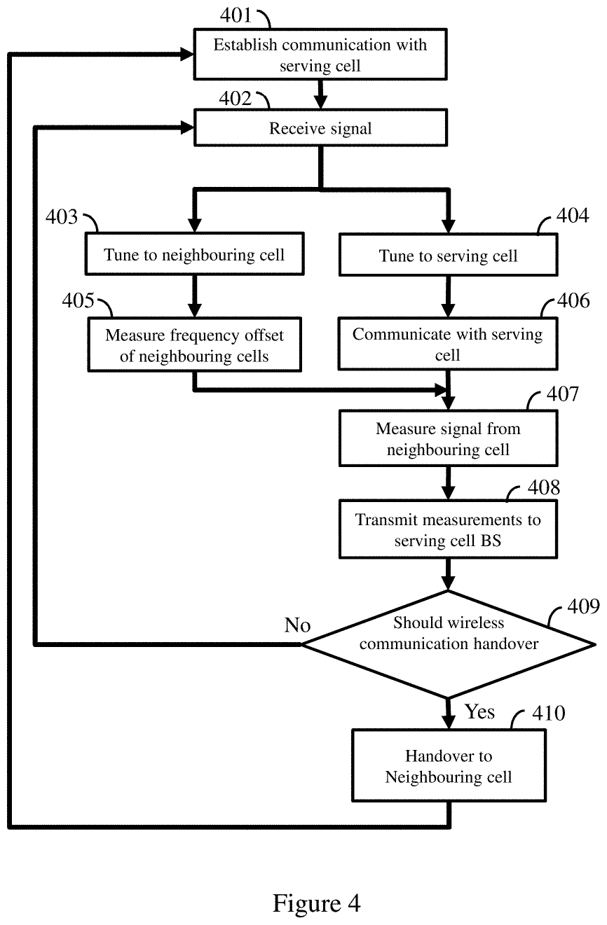

FIG. 4 shows a method for controlling handover according to one embodiment in which neighbouring cell frequency offset is measured. The method of FIG. 4 is similar to that of FIG. 3; however, step 305 in which the signal from the neighbouring cells are measured is replaced with a step in which the frequency offset of each of the one or more neighbouring cells is determined 405. In this step the UE calculates the frequency offsets of each of the one or more neighbouring cells 405 in parallel to communicating with the serving cell 406. The frequency offset is then used by the UE during the measurement gap to enable prompt acquisition of the neighbouring cell's transmission. By pre-calculating the frequency offset to apply to the UE's tuning equipment the method is able to promptly acquire a neighbouring cell's signal. This ensures the UE can measure a neighbouring base station quickly and accurately during a break in serving cell communication. It is clear that more than one neighbour cell frequency offset can also be measured and recorded to allow the option of measuring more than one neighbour during the measurement gap.

The method described above can be further adapted for use in communication systems where one or more antenna units exist for the purpose of providing spatial diversity. In such an embodiment the serving cell signal received by each of the antenna units is measured.

During the course of communication it is likely that channel quality may reduce or degrade. In an airborne environment this situation could arise when the aircraft is banking, causing part of the airframe such as the engine to block line-of-sight communication with the serving cell.

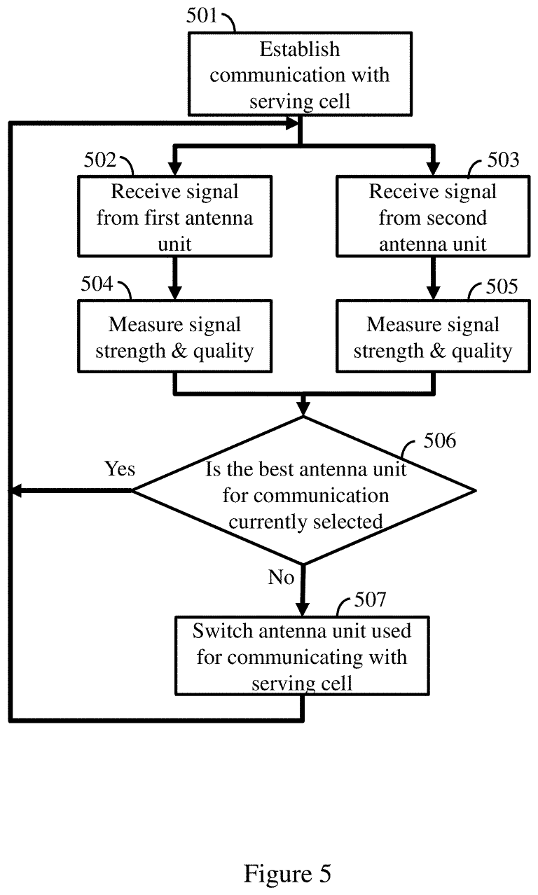

FIG. 5 shows a method for selecting the antenna unit used for communicating with a serving cell according to one embodiment. Measurements received from the different antenna units are used to inform a selection regarding the antenna unit used for communication with the serving cell. In accordance with the embodiments described above the measurements used to compare signals received by the different antenna units could include the RSRQ and the RSRP.

FIG. 5 begins by establishing communication with the serving cell 501. A first signal, originating from a first antenna unit 502, is subsequently received and the strength and quality of this signal is measured 504. In parallel to 502 & 504 a second signal is received from a second antenna unit 503, this signal is also measured to determine the signal strength & quality 505. Once signals from both the antenna units have been measured the measurements are used to determine whether an appropriate antenna unit for communication is presently selected 506. If the most appropriate antenna unit for communication is currently selected the current antenna configuration is maintained and the processor continues to receive and measure signals from the different antenna units 502, 503. If the most appropriate antenna unit for communication is not presently selected, the antenna unit used for communication with the serving cell is switched to be the most appropriate antenna unit 507.

Deciding when to change the antenna unit used for communicating with the serving cell may be based on a number of factors. These can include instantaneous or averaged measurements from the different antenna units. One way of deciding when to switch is to compare the serving cell's signal power or signal quality recorded using the current antenna unit/RRH with the equivalent value recorded using a target antenna unit/RRH. Upon measuring these values a decision to switch can be made if the values recorded for the target antenna unit exceed the values recorded for the current antenna unit by a threshold. To improve the reliability of the measurements, results from a number of sub-frames can be averaged.

In a further embodiment the two parallel signal strength & quality units can be replaced by a single unit which is shared between communication paths on a time basis. In this case the measurement gap is used to measure the second antenna whilst communicating outside the measurement gap using the first antenna unit.

In another embodiment the method includes determining improved communication settings such as an improved antenna configuration. In communication systems containing multiple antennas (e.g. MIMO systems) it is possible to control which antenna elements are used for communication at any one time.

In one embodiment, the method calculates the optimum antenna configuration for communication with the serving cell in parallel to communication with a serving cell. The optimum antenna configuration is an antenna configuration that provides improved performance over alternative configurations. For example, an antenna unit may comprise two antenna elements each of different polarisations and may allow MIMO operation. If there are two antenna units and the system only requires two elements for communication with the serving cell, then the best two out of the four elements can be chosen for optimum performance. In this example two elements not being used for communication may be measured in parallel to the two elements being used for serving cell communication in order to decide on the choice of best two antenna elements to support MIMO performance.

In a further embodiment, in addition to measuring the serving cell, each antenna unit not presently selected for communication with the serving cell can be used to measure signal quality and power of the neighbouring cells, for the purposes of cell handover.

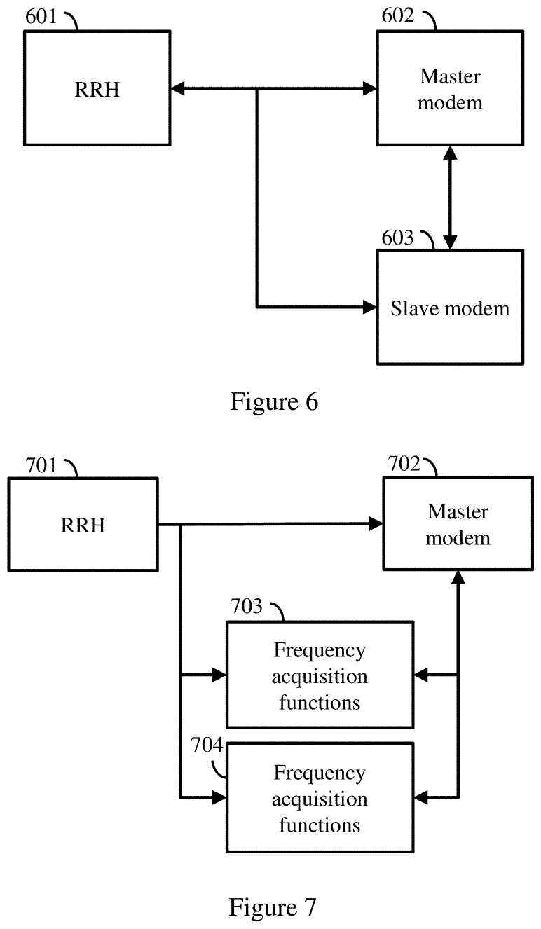

FIG. 6 shows a device for use in wireless communication according to one embodiment. The device may be configured to perform one or more of the methods described above. A remote radio head, RRH, 601 is used as a means to receive and transmit radio frequency signals. The term RRH is used to describe a device comprising components necessary to transform a digital signal into a RF signal suitable for transmission, while also containing the components required to transform a received RF signal into a digital signal. Components may include amplifiers, filters, RF to Baseband converters and digitisers. While the subsequent embodiments are described with reference to a RRH, a person skilled in the art will appreciate that the RRH can be replaced by any device suitable for converting digital signals to electromagnetic waves and vice versa. A remote radio head may also be considered to be a type of antenna unit.

In addition to a Remote Radio Head 601, FIG. 6 also shows a device comprising a number of modems 602, 603. In the following embodiments a modem is used as a term to characterise a device capable of modulating and demodulating a signal, acquiring and tracking a signal during routine operation and performing signal measurements.

The two modems 602, 603 of FIG. 6 are shown in a master-slave relationship. The Remote Radio Head 601 is connected to the master modem 602 and the slave modem 603. The master modem 602 is also connected to the slave modem 603.

The terms master and slave are used to describe information flow between the two modems. In FIG. 6 the master modem 602 supplies the slave modem 603 with information regarding neighbouring base stations. This information can optionally include the nominal operating frequency and the cell ID. The slave modem 603 receives this information and in response informs the master modem of the measurements it makes.

In FIG. 6 the master modem 602 is configured to communicate with the serving base station via the remote radio head 601. In addition to the master modem 602 the signal received from the RRH 601 is also connected to the input of the slave modem. This received signal contains, not only the downlink signal from the serving cell but also downlink signals from neighbouring cells.

The RRH 601 converts the received signal from radio frequencies to baseband. When neighbouring cells use the same nominal transmission frequency as the serving cell the output of the RRH will be tuned to the nominal frequency of both the serving cell and the neighbouring cell. Due to the different Doppler offsets present for each of the signals, it is necessary to acquire the frequency of each signal in order to accurately communicate with the serving cell and measure the neighbouring cell signals. This is achieved using the master 602 and slave modems 603 respectively.

In parallel to the master modem 602 communicating with the serving cell, the slave modem 603 acquires the neighbouring cell's transmission and measures its power and quality. The results of these measurements are subsequently conveyed to the master modem 602 in order to inform a decision regarding cell handover by transmission to the serving cell or locally by the UE.

In an embodiment, measurements of signal power and signal quality may be transmitted from the master modem via the RRH to another device. Optionally the other device may be a base station (eNodeB). The base station may then make a determination regarding whether handover should occur. If it should, the base station can convey this information to the UE to tell it to begin handover. Alternatively, in a non-LTE system the master modem (or slave modem) may make the determination regarding whether handover should occur, and if so, may communicate this decision to the relevant base stations.

By using separate modems with separate frequency correction functionality the slave modem is able to apply frequency correction to the received neighbour cell signal independently of the frequency correction applied by the master modem 602 to communicate with the serving cell. This provides correct measurements of the respective signals, particularly in situations where the frequency offsets will be large, for instance, where there is a large relative Doppler shift between the two cell signals.

FIG. 7 shows a device for use in wireless communication according to one embodiment wherein measurement of the wireless network is performed by frequency acquisition functions 703, 704. In FIG. 7, the slave modem is replaced by one or more frequency acquisition functions 703, 704. In the embodiment of FIG. 6, a separate slave modem 603 is used to measure neighbouring cells wherein the slave modem has the same functionality as the master modem. In contrast, FIG. 7 utilises frequency acquisition functions that are specifically designed to measure the frequency offset of a signal. These functions may be performed by any suitable technology including dedicated hardware, modems or processors.

The measured frequency offset is used by the modem 702 during the measurement gap to enable rapid acquisition of the neighbouring cell transmission. By pre-calculating the frequency of the neighbouring cell, it is possible to accurately tune the UE to a neighbouring cell's transmission without having to first acquire the signal in the measurement gap. This is particularly useful in high Doppler environments where a cell's transmission can deviate considerably from the nominal transmission frequency. As a result of pre-calculating the neighbouring cell's frequency offset it is possible to use the measurement gap to quickly measure the neighbouring cell's signal as opposed to spending part of the measurement gap acquiring the signal before measurement can take place.

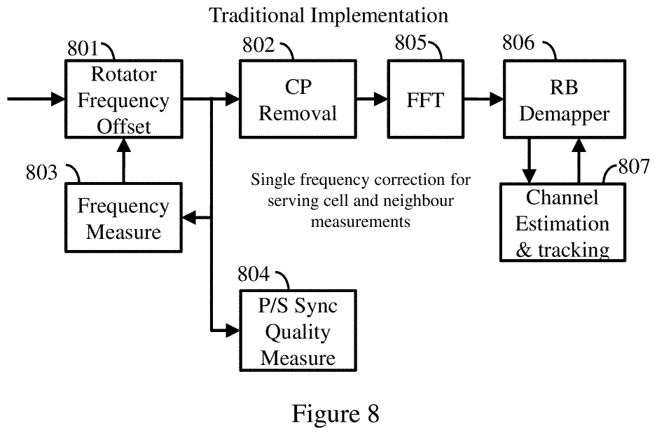

FIG. 8 shows an exemplary LTE UE receiver architecture. In FIG. 8 the signal input is connected to a rotator frequency offset component 801. The rotator frequency offset component 801 is used to correct carrier frequency offsets caused by differences between the transmitter's and the receiver's local oscillators. In addition to oscillator difference compensation, the rotator frequency offset can also be used to correct for variations in the observed cell frequency due to Doppler shift.

The output of the rotator frequency offset 801 is fed to: a frequency measure component 803 and a quality measure block 804 as well as to the rest of the modem via the cyclic prefix removal component 802. The cyclic prefix removal block 802, FFT 805, RB mapper 806 and channel estimation and tracking 807 are standard LTE modem components and it is assumed that a person skilled in the art would understand the details of their operation. The output from this functionality is the serving cell traffic.

The input to the frequency measure component 803 is fed from the output of the rotator frequency offset component 801. This component measures the frequency offset of the input signal. The measured frequency offset is then fed to the rotator in order to compensate for the frequency offset. The compensation should reduce the frequency offset to zero. Any variations of the frequency in time will result in a non-zero frequency offset from the Rotator which will then allow automatic adaption.

The frequency compensated output of 801 is also fed to a P/S sync quality measure component 804. This component uses two received LTE synchronisation signals (a Primary Synchronisation Signal (PSS) and a Secondary Synchronisation Signal (SSS)) correlated against a local code sequence to give a maximised value when the correct frequency offset is applied to the rotator. This process is iterative and can take a number of sub-frames to converge on the correct frequency measurements.

As previously discussed, using a single modem with this configuration can lead to incorrect measurements when operating in high Doppler environments. By using a second modem (or another signal monitoring component) as described above; the embodiments described herein provide a secondary path which can acquire and track a neighbouring cell's signal without affecting the components used for communication with the serving cell.

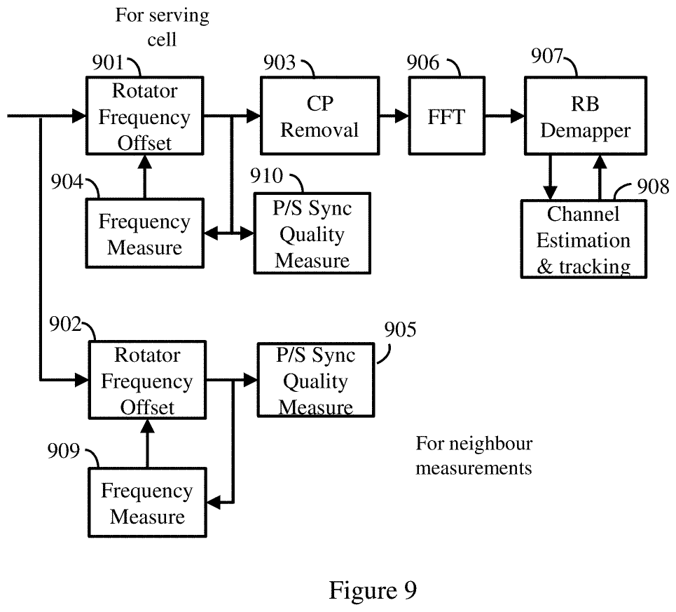

FIG. 9 shows a receiver architecture comprising additional components used to implement a frequency acquisition function according to an embodiment. The system is similar to that of FIG. 8 but further includes a frequency acquisition function that comprises an additional; rotator frequency offset component 902 for measuring neighbouring cells, a Frequency measure component 909 and a PSS(Primary Synchronisation Signal)/SSS (Secondary Synchronisation Signal) Quality measure component 905.

The frequency measure functions 904 & 909 shown in FIG. 9 are shown as two separate components, however they could equally be implemented as one component that is time shared between serving cell and neighbouring cell measurement.

FIG. 9 shows a frequency acquisition function having a second rotator 902 feeding a Frequency measurement function 909. The second rotator 902 with the frequency (offset) measure function is used to remove the frequency offset of neighbouring cells while a separate branch continues to concurrently use the first rotator to remove serving cell frequency offset and feed the rest of the modem functions (e.g. Cyclic Prefix (CP) removal 903 and Resource block (RB) de-mapping 907) in order to produce traffic data.

Frequency acquisition functions can be implemented on multiple technologies, including an application specific integrated circuit (ASIC), a field programmable gate array (FPGA) or in software. Optionally the measured frequency offset can be recorded, which at the appropriate time, is accessed by the master modem.

Using specific frequency acquisition functions is advantageous for a number of reasons. By their very nature, frequency acquisition functions are not intended for use with a specific communication standard. This is advantageous because frequency acquisitions functions can be designed to tolerate larger frequency offsets than are anticipated by standard modems, which are designed to meet the limits dictated by the relevant communication standard. This is especially important in airborne scenarios where aircraft speeds can often exceed the limits specified in LTE.

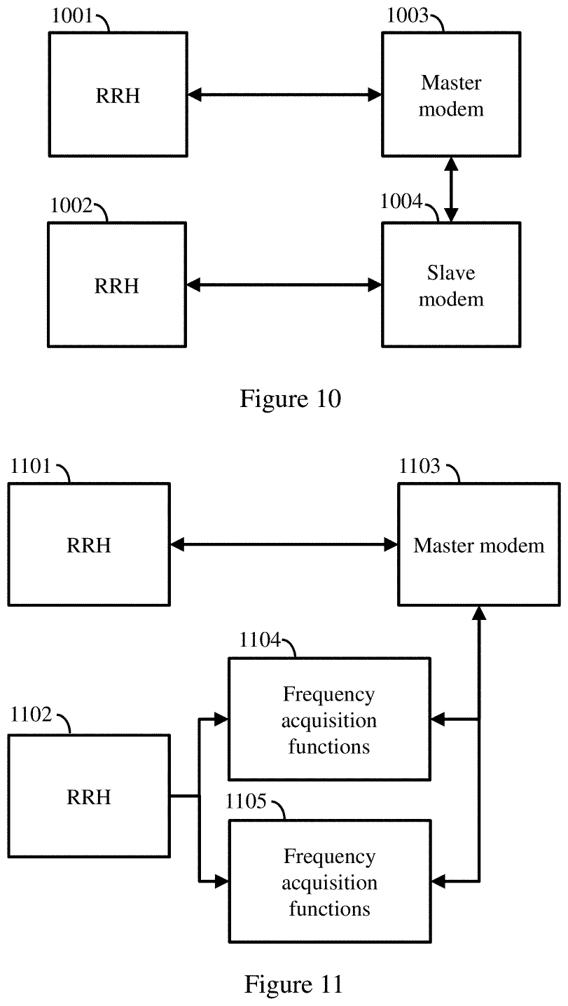

FIG. 10 shows a device for use in wireless communication according to one embodiment wherein each modem 1003, 1004 is served by a different remote radio head 1001, 1002. FIG. 10 is similar to FIG. 6; however, in this embodiment the slave modem 1004 is connected to a second remote radio head 1002, rather than the remote radio head 1001 that serves the master modem. This configuration enables the master modem 1003 and the slave modem 1004 to independently control each RRH respectively. This arrangement has the advantage that each RRH can be tuned to a different frequency, this allows the slave modem to measure neighbour cells when, due to Doppler, they are at a different frequency to the serving cell and also in cases where the neighbour cells are at a different nominal frequency from the serving cell.

FIG. 11 shows a device for use in wireless communication according to one embodiment wherein the frequency acquisition functions 1104, 1105 are fed by a different remote radio head 1102 to the modem 1103. The embodiment of FIG. 11 operates in a manner similar to FIG. 7; however, unlike FIG. 7, the one or more frequency acquisition functions 1104, 1105 are fed by a separate RRH 1102 to the master modem 1103. This arrangement has the advantage that each RRH can be tuned to a different frequency, this allows the slave modem to measure neighbour cells frequency offset which can then be fed to the master modem during the measurement window to allow rapid measurement of the neighbour cell signal rather than having to wait for the master modem to acquire the neighbour cell frequency.

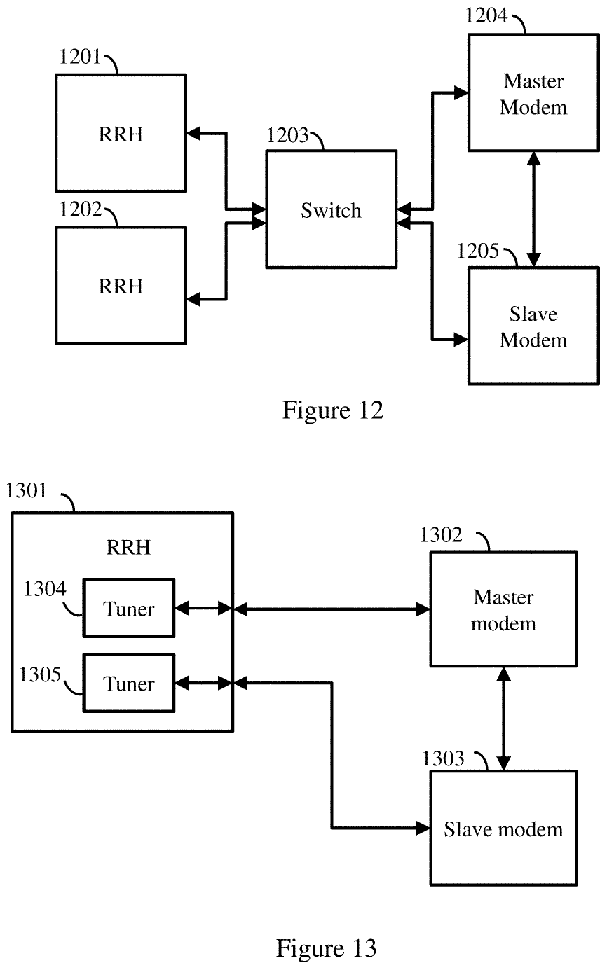

In airborne environments a second antenna with a remote radio head can also be used to provide spatial diversity. As discussed previously, situations can arrive during normal operation where the main antenna unit is blocked or the signal is suddenly attenuated. The remote radio heads of FIG. 12 may be positioned in different physical locations, such that if one antenna and its remote RRH were to be blocked at any time, the other antenna and its RRH would not be blocked.

FIG. 12 shows a device for use in wireless communication according to one embodiment wherein a switch 1203 is used to control which remote radio head 1201, 1202 is used to feed both modems 1204, 1205. Similar to the embodiments of FIGS. 6 and 10, FIG. 12 shows a device which contains two modems 1204, 1205 that are able to exchange information between each other. In addition to the elements of the device shown in FIG. 10, the present embodiment also comprises a switch 1203 that is connected to both modems and to both remote radio heads.

The term “switch” is used to describe a reconfigurable device with multiple input and output ports wherein the switch can be configured to route a signal from any of the input ports to any of the output ports.

During operation both modems measure the signal quality and power of the serving cell via their respective remote radio heads 1201, 1202. If the measurements of the serving cell obtained from the second RRH 1202 exceed the measurements from RRH 1201 by a predefined margin the Master modem will instruct the switch 1203 to change state and connect the current master modem to the other RRH. To avoid excessive switching averaging of measurements can be used. In the embodiment described above the decision to switch remote radio heads may be initiated by comparing instantaneous measurements of the serving cell made by each modem. These measurements could be of the signal and/or quality of the serving cell. In an LTE system these may be the RSRP and the RSRQ. Alternatively the decision to switch RRHs may be initiated when the measured signal quality of the serving cell is recorded below a pre-defined threshold. Furthermore, the decision may be based on one or more averages of any of the measurements.

In the embodiment described above the decision to switch remote radio heads is made by the master modem 1204 but in a different embodiment the slave modem 1205 is responsible for reconfiguring the switch.

In addition, or alternatively to, the antenna switching discussed above, the system may be configured to also switch between antenna elements within the remote radio head 1201, 1202. A similar switching mechanism may be implemented to that discussed with regard to FIG. 12; however, instead of switching between remote radio heads, the system monitors the serving cell signal over different antenna elements or sets of antenna elements and switches to the most effective antenna element or set of antenna elements.

The inclusion of a switch can also be used in a further embodiment where the unused RRH, that is the one not being used for serving cell communication, can be connected to the slave modem and then can be used to measure neighbour cells, this arrangement has the advantage that each RRH can be tuned to a different frequency, so this allows the slave modem to measure neighbour cells when due to Doppler they are at a different frequency to the serving cell and also in cases where the neighbour cells are at a different nominal frequency from the serving cell.

FIG. 13 shows a device for use in wireless communication according to one embodiment wherein a RRH comprises a plurality of independent channel tuners. In FIG. 13 a RRH 1301 comprises a plurality of independent channel tuners 1304, 1305. Each independent channel tuner is controlled by a separate modem 1302, 1303. This configuration allows the slave modem to independently compensate and measure signals from neighbouring cells when the neighbouring cells use a different nominal frequency to the serving cell. As a result of the plurality of independent channel tuners only a single RRH is required to achieve this functionality. Although in alternative embodiments that provide special diversity there may be two RRH each with a plurality of tuners and a switch to choose the best antenna/RRH combination.

The systems and methods described herein allow for accurate measurement and selection of communication paths for a wireless communication system. A communication path may be communication to/from a specific base station or may be communication via a specific antenna, antenna element, set of antennas or set of antenna elements. By implementing independent signal compensation mechanisms (for instance, independent frequency compensation functions) for each communication path, the differences between the two paths can be more effectively corrected. Accordingly, the signals from each path may be more accurately measured. This allows a more effective decision with regard to whether to hand over communication between the two paths or not. Accordingly, the embodiments described herein allow for more effective handover between neighbouring base stations or between different antennas or antenna elements.

Whilst the above embodiments for selecting base stations have been described in the context of air to ground communication, the embodiments are equally applicable to any scenario, and in particular, scenarios where two parties that have a large relative velocity difference are attempting to communicate with each other. Accordingly, the embodiments described herein are effective in any scenario where the Doppler effect on communications is relatively large. Furthermore, whilst the above embodiments are described in the context of the LTE standard, the embodiments described herein are equally applicable to any wireless communication standard.

Implementations of the subject matter and the operations described in this specification can be realized in digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A method comprising:
receiving an input from one or more antennas, the input comprising a first component received over a first communication path from a serving base station and a second component received over a second communication path that is different to the first communication path;
performing signal compensation on the first component over a communication branch, measuring one or more indications of strength, quality or frequency of the first component and communicating wirelessly with the serving base station over the communication branch; and
in parallel to the communication branch, performing signal compensation on the second component over a measurement branch and measuring one or more indications of strength, quality or frequency of the second component in order to assist a decision regarding handover of communication to the second communication path.

2. A method in accordance with claim 1 wherein signal compensation comprises one or more of frequency compensation or channel equalisation.

3. A method in accordance with claim 1 wherein assisting in a decision regarding handover of communication to the second communication path comprises:
comparing the indications of one or more of strength, quality or frequency of the first component and the one or more indications of strength, quality or frequency of the second component; and
making a decision based on the comparison to switch the first component of the input from the signal received over the first communication path to the signal received over the second communication path.

4. A method in accordance with claim 1 wherein each of the measured one or more indications of strength or quality are communicated to the serving base station to allow the serving base station to determine whether to initiate handover of communication to the second communication path.

5. A method in accordance with claim 1 wherein;
the first communication path is a path between the serving base station and the one or more antennas; and
the second communication path is a path between a further base station and the one or more antennas.

6. A method in accordance with claim 1 wherein the one or more antennas comprise a first antenna and a second antenna and wherein:
the first communication path is a path between the serving base station and the first antenna; and
the second communication path is either a path between the serving base station and the second antenna or a path between a further base station and the second antenna.

7. A method in accordance with claim 1 wherein each antenna of the one or more antennas comprise a first antenna element and a second antenna element and wherein;
the first communication path is a path between the serving base station and the first antenna element; and
the second communication path is either a path between the serving base station and the second antenna element or a path between a further base station and the second antenna element.

8. A method in accordance with claim 1 wherein the one or more indications of strength or quality comprise one or more of an indication of received signal power and an indication of received signal quality.

9. A method in accordance with claim 1 wherein measuring one or more indications of strength, quality or frequency of the second component comprises measuring a frequency offset of the second component of the input signal.

10. A method in accordance with claim 1, wherein the communication branch comprises a first modem and the measurement branch comprises a second modem, wherein communicating wirelessly with the serving base station is performed by the first modem and the measurement of the one or more indications of strength or quality of the second component is performed by the second modem.

11. A device for communicating in a wireless network, the device comprising:
an input for receiving a signal from the wireless network, the signal comprising a first component received over a first communication path from a serving base station and a second component received over a second communication path that is different from the first communication path;
an output for outputting a signal to the wireless network;
a communication branch connected to the input and output and configured to perform signal compensation on the first component, measure one or more indications of strength, quality or frequency of the first component and communicate wirelessly with the serving base station via the input and the output; and
a measurement branch connected to the input and output in parallel to the communication branch and configured to perform signal compensation on the second component and measure one or more indications of strength, quality or frequency of the second component in order to assist a decision regarding handover of communication to the second communication path.

12. A device in accordance with claim 11 wherein signal compensation comprises one or more of frequency compensation or channel equalisation.

13. A device in accordance with claim 11 wherein assisting in a decision regarding handover of communication to the second communication path comprises:
comparing the one or more indications of strength, quality or frequency of the first component and the one or more indications of strength, quality or frequency of the second component; and
making a decision based on the comparison to switch the first component of the input from the signal received over the first communication path to the signal received over the second communication path.

14. A device in accordance with claim 11 wherein the device is further configured to communicate each of the measured one or more indications of strength or quality to the serving base station, via the output, to allow the serving base station to determine whether to initiate handover of communication to the second communication path.

15. A device in accordance with claim 11 wherein;
the first communication path is a path between the serving base station and the one or more antennas; and
the second communication path is a path between a further base station and the one or more antennas.

16. A device in accordance with claim 11 wherein the one or more antennas comprise a first antenna and a second antenna and wherein:
the first communication path is a path between the serving base station and the first antenna; and
the second communication path is either a path between the serving base station and the second antenna or a path between a further base station and the second antenna.

17. A device in accordance with claim 11 wherein each antenna of the one or more antennas comprise a first antenna element and a second antenna element and wherein;
the first communication path is a path between the serving base station and the first antenna element; and
the second communication path is either a path between the serving base station and the second antenna element or a path between a further base station and the second antenna element.

18. A device in accordance with claim 11, wherein the one or more indications of strength or quality comprise one or more of an indication of received signal power and an indication of received signal quality.

19. A device in accordance with claim 11, wherein measuring one or more indications of strength, quality or frequency of the second component comprises measuring a frequency offset of the second component of the input signal.

20. A device in accordance with claim 11, wherein the communication branch comprises a first modem and the measurement branch comprises a second modem, wherein communicating wirelessly with the serving base station is performed by the first modem and the measurement of the one or more indications of strength or quality of the second component is performed by the second modem.
